(19) United States
(12) Patent Application Publication
(10) Pub. No.: US 2009/0267865 A1
(43) Pub. Date: Oct. 29, 2009

(54) Field Antenna

(75) Inventors: Paul E. Miller, Spring Lake, MI (US); John Jeremy Churchill Platt, Grand Haven, MI (US); Joe J. Furey, Grand Haven, MI (US); Susan Boelkins, Muskegon, MI (US)

Correspondence Address: MCGARRY BAIR PC, 32 Market Ave. SW, SUITE 500, GRAND RAPIDS, MI, 49503, US

(73) Assignee: R.A. MILLER INDUSTRIES, INC., Grand Haven, MI (US)

(21) Appl. No.: 12/428,029

(22) Filed: Apr. 22, 2009

Related U.S. Application Data
(60) Provisional application No. 61/047,272, filed on Apr. 23, 2008.

(51) Int. Cl. H01Q 1/10

(52) U.S. Cl. 343/901

(57) ABSTRACT

A field antenna comprises an antenna assembly and an optional mast assembly. The antenna assembly can comprise two antenna portions coupled to a feedcone assembly as a single foldable unit. The mast assembly can comprise a unitary telescoping mast. The field antenna can be part of an antenna kit that can be disassembled and packed in a transit bag for storage and transport. The antenna assembly can be used as a field antenna alone, or can be selectively mounted to the mast assembly or a vehicle.

### CROSS-REFERENCE TO RELATED APPLICATION

This application claims the benefit of U.S. provisional application No. 61/047,272, filed Apr. 23, 2008, which is incorporated herein by reference in its entirety.

### BACKGROUND OF THE INVENTION

1. Field of the Invention

The present invention relates generally to antennas, and more specifically to field antennas designed for compact transport and quick assembly.

2. Description of the Related Art

It is known to construct antennas for field use that can be transported to a location in the field and erected in a short time to establish a radio communication link. The antennas are also constructed to be disassembled and packed for transport to a different location in the field. Such antennas are commonly used for military operations.

FIG. 1 illustrates a prior art field antenna 10, which is referred to in the industry as an OE-254. The field antenna 10 is an omnidirectional, biconical antenna designed for broadband operation without field adjustment in a frequency range of 30-88 MHz and a power capability of up to 350 watts. The field antenna 10 is designed to be assembled or disassembled by a single person, and, when disassembled, packed in a transit bag (not shown) for storage and transport. Other ancillary components used for assembling the field antenna 10, such as spare parts, a technical manual, a hammer, silicone compound, and insulating tape, are also stored in the transit bag. When disassembled, the packed transit bag weighs about 45 lbs and measures 42 inches long and 39 inches in circumference. The packed transit bag is intended to be carried by a single person.

The field antenna 10 comprises an antenna assembly 12 that can be mounted to and supported by a mast assembly 14. The antenna assembly 12 comprises a feedcone assembly 16 an upper antenna portion 18, and a lower antenna portion 20. The feedcone assembly 16 mounts the two antenna portions 18, 20 and a balun assembly 22 and provides for mechanical connection to the mast assembly 14. The upper antenna portion 18 comprises three upwardly extending antenna elements 24 projecting from the feedcone assembly 16 at an angle of approximately 30 degrees from true vertical and arranged in a cone configuration. Similarly, the lower antenna portion 20 comprises three downwardly extending antenna elements 24 projecting from the feedcone assembly 16 at an angle of approximately 30 degrees from true vertical and arranged in a cone configuration. Each antenna element has a first end connected to the feedcone assembly 16 and a second end capped with an eye protection device (EPD) 26, and comprises three separate antenna element sections 28 which are copper plated, painted tubes of high-strength steel that can be screwed together to form one antenna element 24. In total, the antenna assembly comprises twenty-five individual components that are designed to be disassembled and packed in the transit bag.

The mast assembly 14 comprises twelve tubular mast sections 32, an insulating extension 34, a mast stand assembly 36 and a base plate 38. Each mast section 32 has a male and female end, which permits the mast sections 32 to be fitted together into a single unit or mast 30. The mast stand assembly 36 comprises a tubular supporting section attached to a stake (not shown), which is driven into the ground. The lowermost mast section 32 is placed over the tubular section, which is pivotable relative to the stake to allow the mast assembly 14 to be lowered to the ground without removing the stake. The base plate 38 is used to distribute the load of the mast/base assembly 36 and is fixed to the ground using two stakes (not shown). The mast assembly 14 is held in a generally vertical position by eight guy assemblies 42 which are connected between guy stakes 44 anchored to the ground and either an upper guy plate 46 or a lower guy plate 48, both of which are secured to the mast 30 in spaced relation to each other when fitting the mast sections 32 together. In total, the mast assembly 14 comprises twenty-seven individual components that are designed to be disassembled and packed in the transit bag.

A cable 50 connects to the feedcone assembly 16 at one end and extends down the mast assembly 14 to connect to a radio (not shown). A strain clamp 52 attaches the cable 50 to the upper guy plate 46 and electrical tape 54 is used to lash the cable 50 to the mast 30 at various locations down the mast 30. These individual parts add to the number of components that must be dissembled and packed in the transit bag.

For military operations, quick assembly of the field antenna 10 can be of critical importance, and assembly of the field antenna 10 may need to be accomplished under difficult circumstances. However, due the large number of individual components, it is a time-consuming task to assemble the field antenna 10. The individual parts can become damaged or lost. Furthermore, the large number of components leads to administrative difficulties since each component is tracked according to its own assigned part number. The field antenna 10 is further limited to operation in the 30-88 MHz frequency range.

### SUMMARY OF THE INVENTION

A field antenna for portable transport according to one aspect of the invention comprises an antenna assembly having an upper antenna portion having a single upper antenna element capable of operating in a first frequency range and a second, higher frequency range, a lower antenna portion having multiple lower antenna elements capable of operating in the first frequency range, and a feedcone assembly connecting the upper and lower antenna portions, and having a lower antenna mounting assembly that foldably mounts the lower antenna elements to the feedcone assembly.

A field antenna for portable transport according to one aspect of the invention comprises a mast assembly having a mast and a plurality of guy assemblies attached between the mast and a ground surface for supporting the mast in a generally vertical orientation, and an antenna assembly optionally supported by the mast assembly at an elevated height above a ground surface. The antenna assembly includes a mounting base removably mountable to the mast and a single antenna element mounted to the mounting base and capable of operating in a first frequency range and a second, higher frequency range. The antenna assembly is selectively mountable to one of the mast assembly and a vehicle or other structure.

### BRIEF DESCRIPTION OF THE DRAWINGS

In the drawings:

FIG. 1 is a perspective view of a prior art field antenna.

FIG. 2 is a perspective view of a field antenna according to the invention in a first use configuration and comprising an antenna assembly and a mast assembly.

FIG. 3 is a view of a field antenna kit comprising the field antenna of FIG. 1.

FIG. 4 is a close-up perspective view of the field antenna shown in FIG. 2, illustrating a feedcone assembly of the field antenna.

FIG. 5 is an exploded view of the feedcone assembly from FIG. 4.

FIG. 6 is side partial-section view of the feedcone assembly from FIG. 4.

FIG. 7A is a bottom view of the feedcone assembly, illustrating the feedcone assembly from FIG. 4 in an unlocked position.

FIG. 7B is a bottom view of the feedcone assembly, illustrating the feedcone assembly from FIG. 4 in a locked position.

FIG. 8 is a schematic diagram illustrating the electrical connections of the field antenna.

FIG. 9 is a view of a balun assembly of the feedcone assembly from FIG. 4.

FIG. 10 is an exploded view of the mechanical connection between the antenna assembly and the mast assembly from FIG. 2.

FIG. 11 is an exploded view of a lower portion of the mast assembly from FIG. 2.

FIG. 12 is a view of a guy assembly of the mast assembly from FIG. 2.

FIG. 13 is a view of a winder and tensioner of the guy assembly from FIG. 12

FIG. 14 is a perspective view of a field antenna according to the invention in a second use configuration.

FIG. 15 is a perspective view of a second embodiment of an antenna assembly mounted to a mast assembly.

FIG. 16 is a perspective view of the antenna assembly from FIG. 15 mounted to a vehicle.

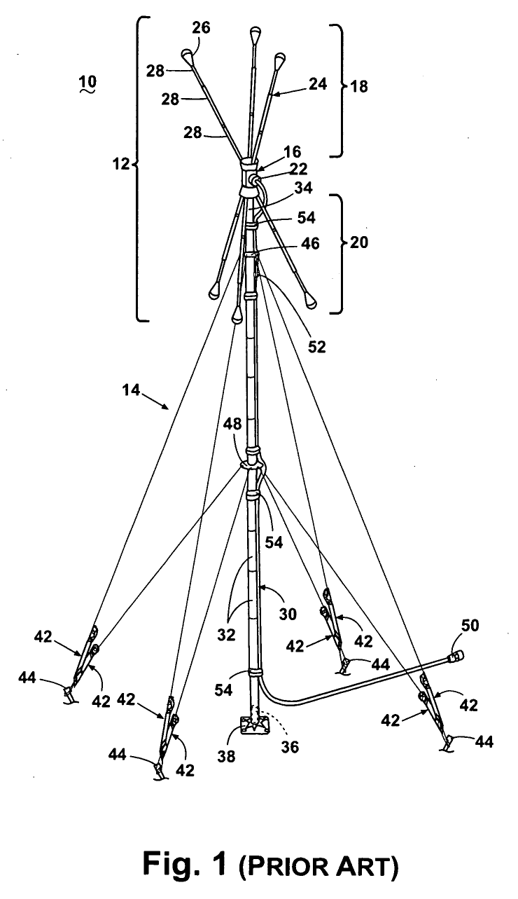

### DESCRIPTION OF AN EMBODIMENT OF THE INVENTION

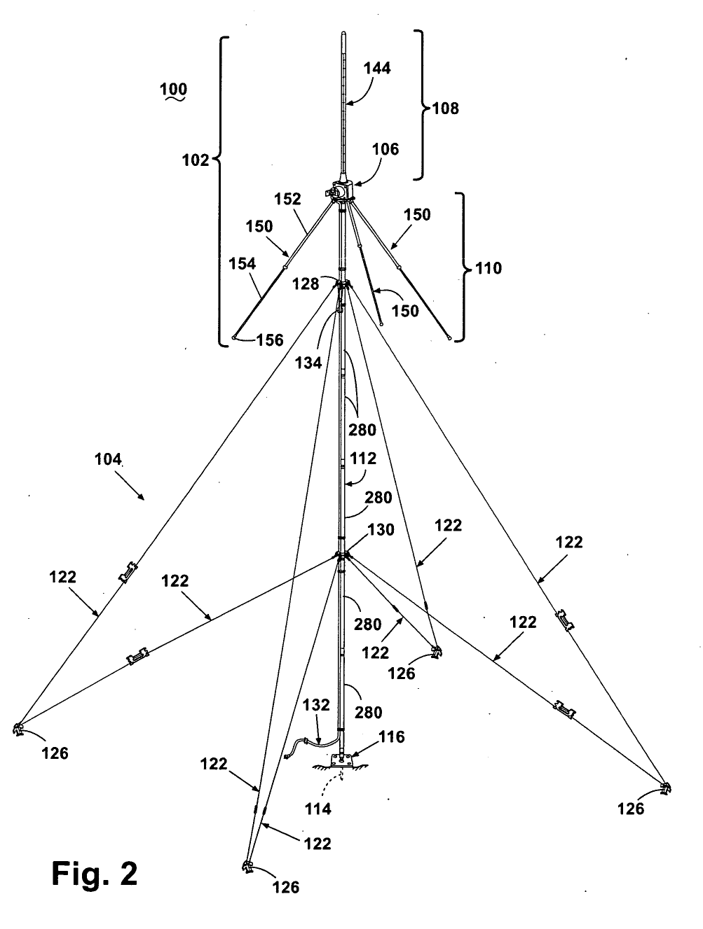

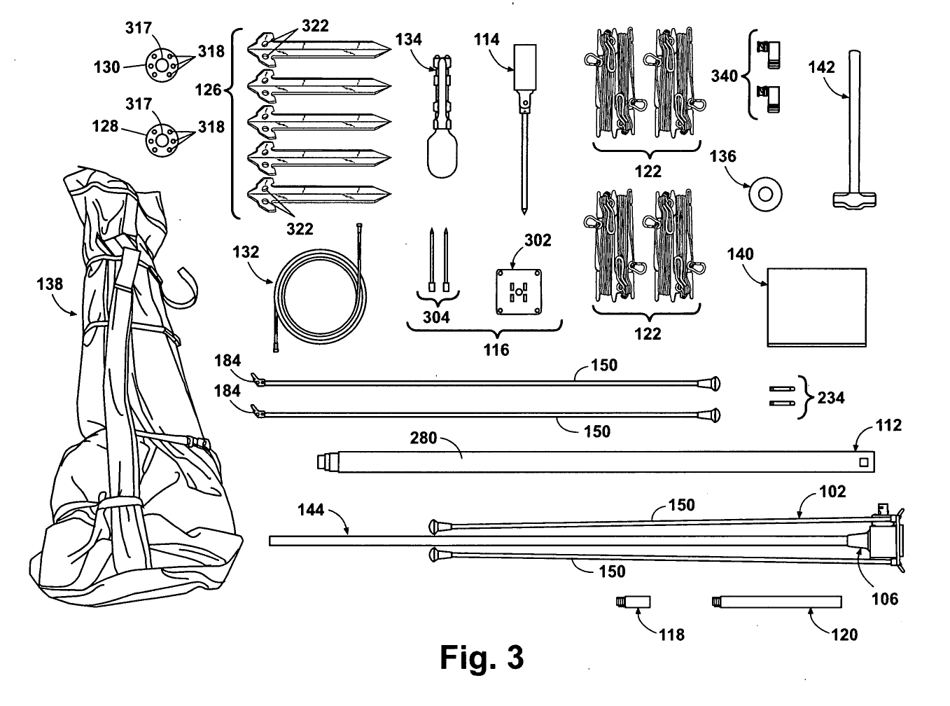

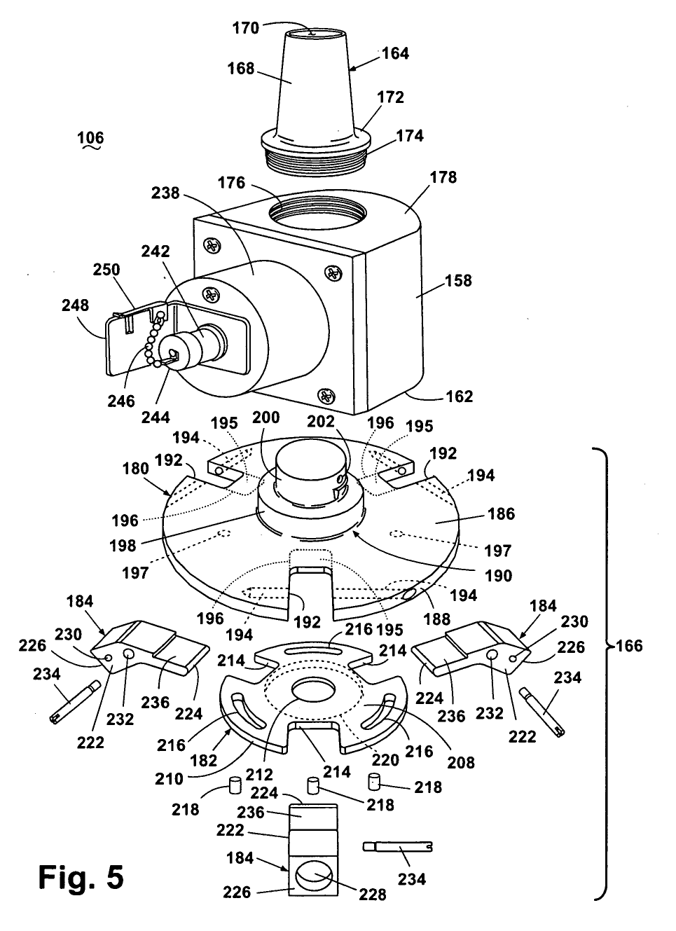

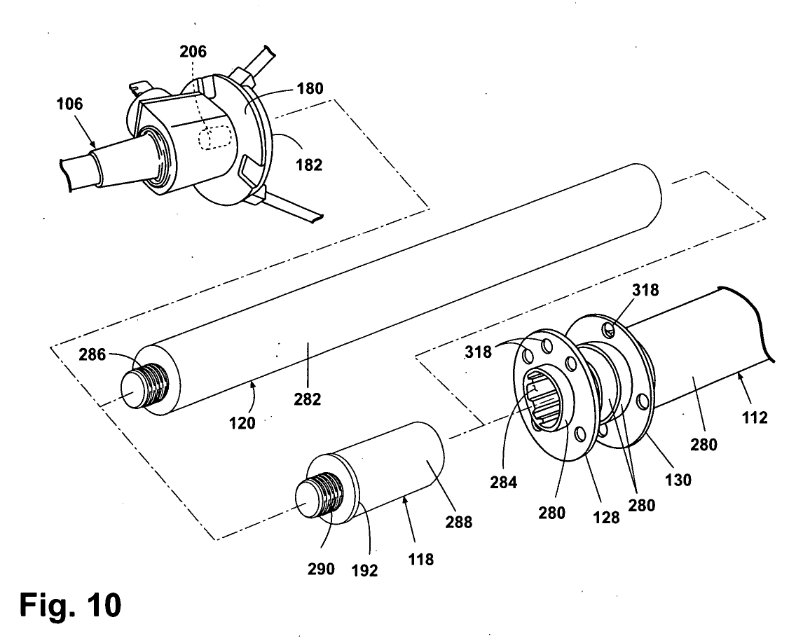

A field antenna 100 according to the present invention is illustrated in FIGS. 2-14. It is understood that the size of elements of the field antenna 100 are exaggerated for illustration purposes and are not drawn to scale or proportion. Referring to FIG. 2, the field antenna 100 comprises an antenna assembly 102 and a mast assembly 104 for optionally supporting the antenna assembly 102 at an elevated height above the ground. The antenna assembly 102 comprises a feedcone assembly 106, an upper antenna portion 108, and a lower antenna portion 110, which can be fixed together to form a single unit or component of the field antenna 100. The mast assembly 104 comprises a unitary mast 112, a mast stand assembly 114, a base plate assembly 116, and, optionally, a mast adapter 118 and an insulating extension 120 (FIG. 3), either of which can be used to connect the mast 112 to the feedcone assembly 106. The mast assembly 104 is held in a generally vertical position by a supporting arrangement comprising guy assemblies 122 that are anchored to the ground by guy stakes 126 and connected between an upper guy plate 128 and a lower guy plate 130, both of which are configured to be secured to the mast 112. A cable 132 connects to the feedcone assembly 106 at one end and extends down the mast assembly 104 to connect to a radio (not shown). A strain clamp 134 attaches the cable 132 to the upper guy plate 128 to eliminate strain on the connection between the cable 132 and the feedcone assembly 106 caused by the weight of the cable 132, and electrical tape 136 (FIG. 3) used to lash the cable to the mast 112 at various locations down the mast 112.

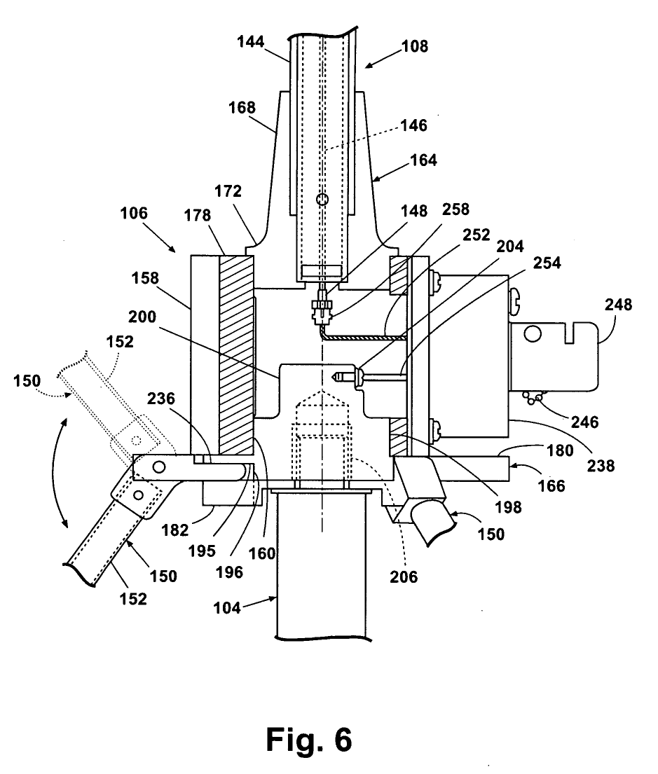

The upper antenna portion 108 comprises a single upwardly extending antenna element 144 projecting approximately vertically from the feedcone assembly 106. The antenna element 144 can comprise a multiband antenna having an open sleeve dipole radiator, such as is disclosed in U.S. Pat. Nos. 7,053,851 and 7,164,389, both of which are incorporated herein by reference in their entirety. The antenna element 144 can comprise multiple dipoles capable of effectively transmitting/receiving at least two frequency bands, such as 30-88 MHz and 225-450 MHz. With reference to FIG. 6, the antenna element 144 includes a transmission line in the form of a coaxial lead 146 having an end portion including a female coax connector 148 received in the feedcone assembly 106.

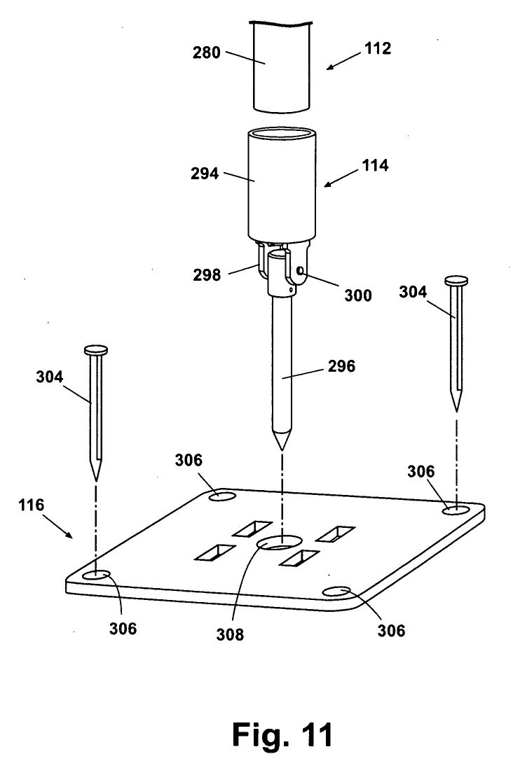

Referring to FIGS. 2 and 3, the lower antenna portion 110 comprises three one-piece antenna elements 150 that are moveably connected to the feedcone assembly 106 between a collapsed configuration shown in FIG. 3, in which the antenna assembly 102 can be packed in the transit bag 138 and a use configuration, two of which are shown in FIGS. 2 and 11, respectively, in which the antenna assembly 102 can be used for transmitting or receiving signals, whether mounted to the mast assembly 104 or not as will be described below. In the collapsed configuration (FIG. 3), the antenna elements 150 are folded to lie almost parallel to the antenna element 144. In the use configurations (FIGS. 2 and 11), the antenna elements 150 project downwardly from the feedcone assembly 106 at an angle of approximately 30 degrees from true vertical and are arranged in a cone configuration. The antenna elements 150 are telescopic, and each comprises at least one outer tubular section 152 and at least one inner tubular section 154 that is moveable with respect to the outer tubular section 152 for receipt within a portion of the outer tubular section 152. In the collapsed configuration (FIG. 3) and in the second use configuration (FIG. 11), the antenna elements 150 are placed in an unextended position in which the inner tubular section 154 is received within the outer tubular section 154, while in the first use configuration (FIG. 2), the antenna elements 150 are placed in an extended position in which the inner tubular section 154 is extended at least partially outwardly from the outer tubular section 152. The proximal end of the outer tubular section 152 is pivotally connected to the feedcone assembly 106. The distal end of the inner tubular section 154 is capped with an EPD 156. The tubular sections 152, 154 can be fabricated from aluminum. The lower antenna portion 110 can be configured to operate in one frequency band, such as 30-88 MHz.

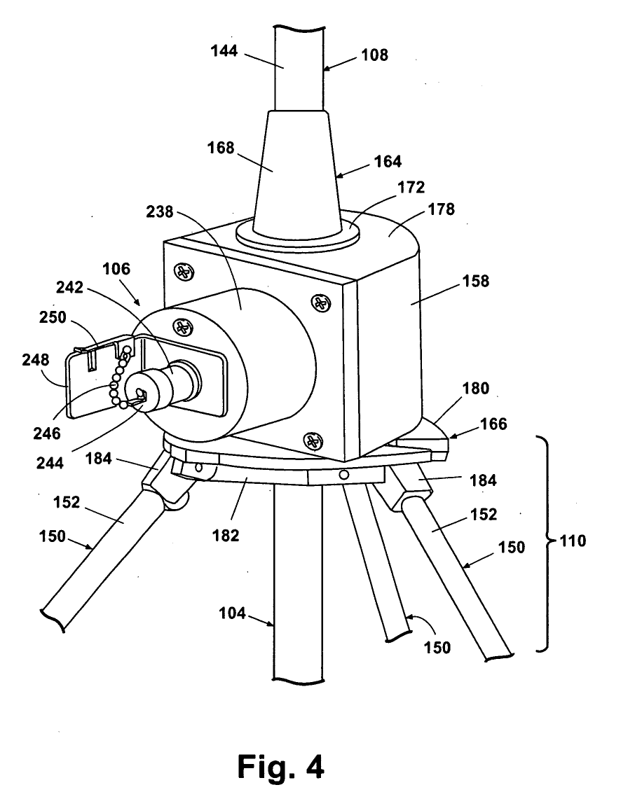

Referring to FIGS. 4-6, the feedcone assembly 106 comprises a feedcone housing 158 which mounts the two antenna portions 108, 110, and provides for mechanical connection to the mast assembly 104. The feedcone assembly 106 further comprises an upper antenna mounting assembly 164 and a lower antenna mounting assembly 166. The upper antenna mounting assembly 164 comprises an adapter 168 which mechanically joins the upper antenna element 144 to the feedcone housing 158. The adapter 168 comprises a hollow annular body having a central passage 170 which receives the lower end of the upper antenna element 144 and is open at its lower end for passage of the coaxial lead 146 into the feedcone housing 158. The adapter 168 further comprises a circumferential flange 172 below which is formed a lower threaded portion 174 that is received in a corresponding threaded opening 176 provided in an upper surface 178 of the feedcone housing 158 such that the flange 172 mates with the upper surface 178. Alternately, the lower portion 174 and opening 176 can be fixed together using adhesion rather than a threaded coupling. The adapter 168 can be affixed to the feedcone housing 158 and the upper antenna element 144 such that the upper antenna element 144 is permanently, semi-permanently, or removably mounted the feedcone assembly 106. To reduce the number of individual components to assembly when erecting the field antenna 100, it is preferred that the adapter 168 be permanently or semi-permanently affixed to both the feedcone housing 158 and the upper antenna element 144.

The lower antenna mounting assembly 166 comprises two plates 180, 182 that are coupled to the lower surface 162 of the feedcone housing 168 and three antenna heads 184 which receive the antenna elements 150. The upper plate 180 comprises a generally flat, disc-shaped body having an annular region 186 that extends radially between a circular peripheral edge 188 and a center protrusion 190. The peripheral edge 188 includes three generally rectangular recesses 192 which correspond to the three downwardly extending antenna elements of the lower antenna portion 110. Each recess 192 is sized to receive one of the antenna heads 184 and has a pivot hole 194 extending through the recess 192 from the peripheral edge 188 to the annular region 186. Depressions 196 are formed in the bottom surface of the upper plate 180 and extend radially from the recesses 192 toward the center protrusion 190. Each depression 196 comprises a conducting surface 195 that is used to establish a conducting path between the lower antenna portion 110 and the feedcone assembly 106. The bottom surface of the upper plate 180 further comprises three radially spaced pin holes 197. The center protrusion 190 comprises a lower cylindrical portion 198 that is sized for insertion through a corresponding opening 160 provided in a lower surface 162 of the feedcone housing 158. The outer surface of the lower cylindrical portion 198 can be adhered to the inner surface of the opening 160 to fixedly mount the upper plate 180 to the feedcone housing 158. An upper cylindrical portion 200 extends upwardly from the lower cylindrical portion 198 and includes a screw hole 202 for receiving a screw 204. A central threaded bore 206 extending into the center protrusion 190 is formed in the bottom surface of the upper plate 180 for connecting the feedcone assembly 106 to the mast assembly 104.

The lower plate 182 comprises a generally flat, disc-shaped body having an annular region 208 that extends radially between a circular peripheral edge 210 and a central opening 212. The peripheral edge 210 includes three generally rectangular recesses 214 which correspond to the three downwardly extending antenna elements of the lower antenna portion 110 and are sized to selectively receive one of the antenna heads 184. The lower plate 182 further comprises arcuate slots 216 formed through the annular region 208 between adjacent recesses 214. The lower plate 182 is rotatably mounted to the upper plate 180 by inserting slot pins 218 through the slots 216 and into the pin holes 197 formed in the bottom surface of the upper plate 180. The slot pins 218 mount the lower plate 182 to the upper plate 180, but allow the lower plate 182 a limited degree of rotation with respect to the upper plate 180 by virtue of the translation of the slot pins 218 within the slots 216. An annular depression 220 surrounding the central opening 212 is formed in the bottom surface of the lower plate 182.

The antenna heads 184 each comprise a first body section 222 joined with a second body section 224 in a dogleg configuration. The first body section 222 has lower angled face 226 with an opening 228 formed therein for receiving the proximal end of the outer tubular section 152 of one of the antenna elements 150. A pin hole 230 is formed through the first body section 222 generally orthogonally to the opening 228 and receives a pin (not shown) to secure the antenna element 150 to the antenna head 184. A pivot hole 232 is formed through the antenna head 184 and is used to secure the antenna head to the upper plate 180. To assemble the antenna head 184 to the upper plate 180, the pivot holes 194, 232 are aligned and a pivot pin 234 is inserted therethrough. The second body section 224 comprises a conducting surface 236 that is selectively mated with the conducting surface 195 of the depression 196 on the upper plate 180 to establish a conducting path between the lower antenna portion 110 and the feedcone assembly 106.

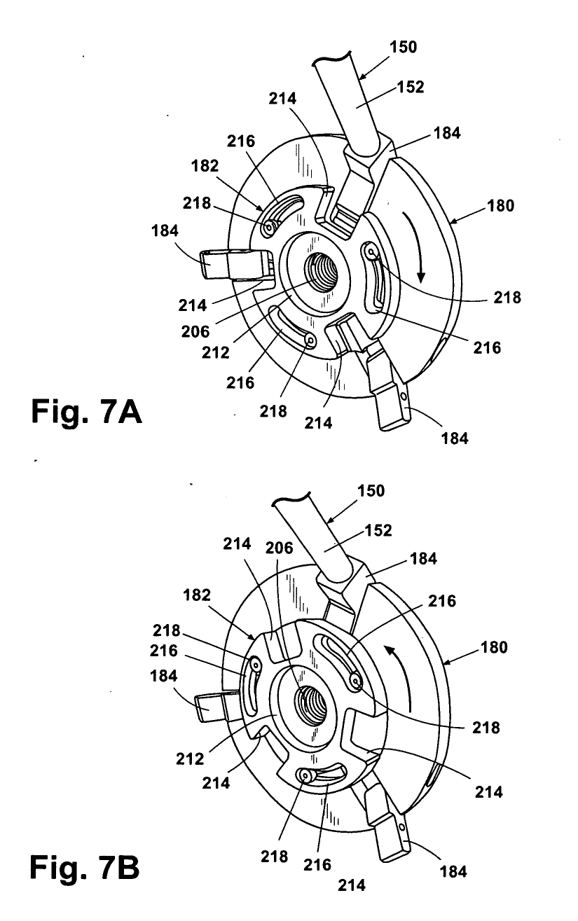

Referring to FIGS. 6 and 7A-B the antenna elements 150 are pivotable about axes defined by the pivot pins 234 with respect to the feedcone assembly 106 to move the antenna assembly 102 between the collapsed configured (FIG. 3) and the use configuration (FIGS. 2 and 11). In the use configuration, the conducting surface 236 of the antenna head 184 mates with the conducting surface 195 on the upper plate 180 to establish a conduction path between the lower antenna portion 110 and the feedcone assembly 106. In the collapsed configuration, the conducting surfaces 195, 236 are not mated, and thus there is no conduction between the lower antenna portion 110 and the feedcone assembly 106. To move the antenna elements 150 to the use configuration, the lower plate 182 is rotated to position the recesses 192, 214 of the both plates 180, 182 in general alignment. To lock the antenna assembly 102 in the use configuration, the lower plate 182 is rotated to move the recess 214 out of alignment with the recess 192, thereby preventing movement of the antenna heads 184 by the overlap of the peripheral edge 210 with the second body portion 224.

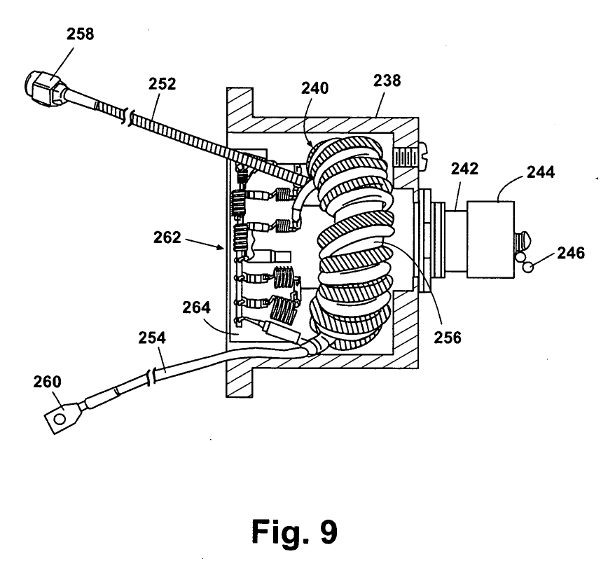

Referring to FIGS. 4 and 9, a balun housing 238 is coupled to the feedcone housing 158, and receives a balun assembly 240. A coaxial female connector 242 that is electrically coupled to the balun assembly 240 is provided on the exterior of the balun housing 238 for connection with the cable 132. The connector 242 can be provided with a cap 244 to cover and protect the connector 242 when the cable 132 is not mounted to the feedcone assembly 106, and can be tethered to the balun housing 238 by a line 246 to prevent the cap 244 from being separated from the feedcone assembly 106 and potentially damaged or lost. A bracket 248 can be provided adjacent the connector 242 that has a retaining clip 250 for securing the line 246 to the bracket 248.

Referring to FIGS. 6 and 9, the balun assembly 240 provides impedance match between the impedances of a radio coupled to the field antenna 100 and the antenna assembly 102. The balun assembly 240 is essentially an impedance transformer that matches impedance at the antenna terminals to the unbalanced transmission line. The balun assembly 240 comprises two windings 252, 254 wrapped around a ferrite toroid core 256. The first winding 252 comprises a coaxial lead having a male coax connector 258 that mates directly with the female coax connector 148 on the coaxial lead 146 of the antenna element 144. The second winding 254 comprises a wire lead having a terminal connector 260 that mates directly with the screw 204 on the upper plate 180.

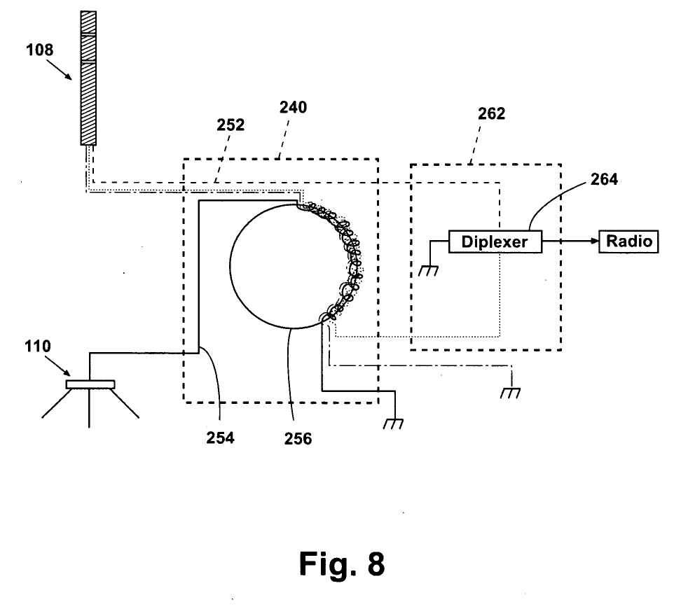

Referring to FIGS. 8 and 9, the balun assembly 240 is coupled to a diplexer assembly 262 to permit the two antenna portions 108, 110 to share a common cable 132. It is understood that if a separate cable were provided for each antenna portion 108, 110, the diplexer assembly 262 would not be needed. The diplexer assembly 262 comprises a diplexer 264 in the form of a circuit board used to mechanically and electrically connect the balun assembly 240 to the cable 132.

Referring to FIGS. 2, 3 and 10, the mast 112 comprises five tubular mast sections 280 that are telescopically joined such that the mast 112 comprises a single unit that is moveable between a collapsed configuration shown in FIG. 3, in which the mast sections 280 are received within one another in a concentric arrangement, and a use configuration shown in FIG. 2 in which the mast sections 280 are extended from each other. The mast 112 can be fabricated from fiberglass or a metal such as steel or aluminum. A metal mast 112 may require the use of the insulating extension 120, which is placed between the mast 112 and the feedcone assembly 10. The insulating extension 120 comprises a cylindrical body portion 282 which is received at least partially received in a lumen 284 defined by the uppermost mast section 280 and a threaded connector 286 formed at one end of the body portion 282 for receipt within the threaded bore 206 on the lower plate 180 of the feedcone assembly 106 to mount the antenna assembly 102 to the mast assembly 104. A fiberglass mast 112 does not require an insulating extension 120, and may be connected to the feedcone assembly 106 via the adapter 118. As illustrated, an adapter 118 comprises a cylindrical body portion 288 and a threaded connector 290 formed at one end of the body portion 288 adjacent a circumferential flange 292. The body portion 288 is sized for reception within the lumen 284 such that the flange 292 rests atop the upper edge of the uppermost tubular section 280. The threaded connector 290 can be received within the threaded bore 206 on the lower plate 180 of the feedcone assembly 106 to mount the antenna assembly 102 to the mast assembly 104. The adapter 118 and the insulating extension 120 can be sized such that they are interchangeably usable with masts 112 having similar dimensions. Alternately, the mast 112 can comprise an integrally formed threaded connector similar to the threaded connectors 286, 290, which would not require the use of the adapter 118 or the insulating extension 120. Whether the adapter 118, insulating extension 120, or an integrally formed threaded connector is used, connection of the mast 112 to the feedcone assembly 106 tightens the plates 180, 182 (FIG. 4) against each other to prevent the lower plate 182 from rotating relative to the upper plate 180.

The guy plates 128, 130 can be slid onto the mast 112 prior to assembly with the adapter 118 or insulating extension 120, if either is used. Each guy plate 128, 130 comprise a central opening 317 surrounded by multiple peripheral holes 318. The central opening 317 is sized so each the guy plate 128, 130 fits to the proper mast section 280 to such that the guy plates 128, 130 are at suitable heights when the mast 112 is extended. Alternately, the guy plates 128, 130 can be fixed to the mast 112 such that they are not removed from the mast 112 during disassembly. This arrangement would further reduce the number of individual components of the field antenna 100.

Referring to FIG. 11, the mast stand assembly 114 comprises a hollow tubular supporting section 294 attached to a stake 296. In use, the stake 296 is driven into the ground and the lowermost mast section 280 is received inside the supporting section 294. The supporting section 294 can be attached to the stake 296 by a yoke 298 and clevis pin 300 to allow the mast 112 to be lowered to the ground without removing the stake 296. The base plate assembly 116 comprises a base plate 302 and at least two stakes 304 configured for insertion through corresponding stake holes 306 in the base plate 302 to fix the base plate 302 to the ground. The base plate 302 further comprises a central stake hole 308 through which the stake 296 of the mast stand assembly 114 is inserted. The base plate 302 can be keyed for proper orientation of the mast assembly 104.

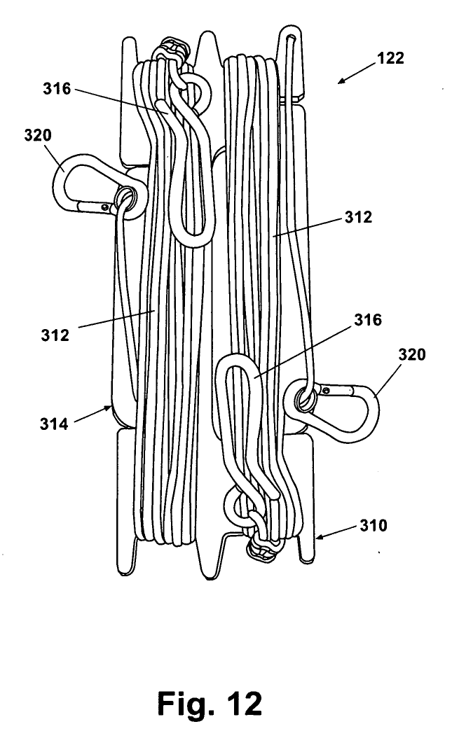

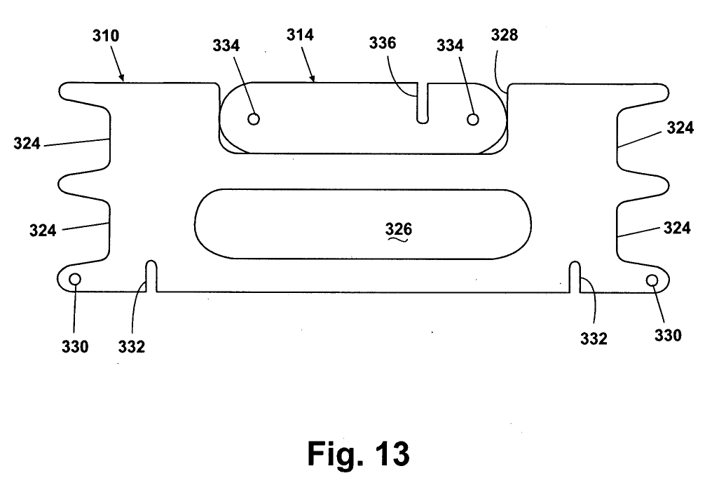

Referring to FIGS. 12 and 13, each guy assembly 122 comprises a winder 310 connected to two guys ropes 312 and a tensioner 314 for the guy ropes 312. Each guy rope 312 has fasteners at either end for coupling the guy rope 312 between one of the guy stakes 126 and one of the guy plates 128, 130. As illustrated, the guy ropes 312 have a hook-type fastener 316 at one end for connection to one of the multiple holes 318 formed in guy plates 128, 130 and a carabineer-type fastener 320 at the other end for connection to one of the holes 322 formed in the guy stakes. The two guy ropes 312 on each guy assembly 122 can have different lengths in correspondence with the different heights of the guy plates 128, 130. Optionally, the guy rope 312 corresponding to the upper guy plate 128 can have a length of approximately 28 ft. and the guy rope corresponding to the lower guy plate 130 can have a length of approximately 22 ft. The hook-type fasteners 316 can be color-coded to correspond to a matching guy plate 128, 130 so that the proper-length guy rope 312 is attached to the correct guy plate 128, 130.

The winder 310 comprises a generally flat body formed with two spool sections 324, a grip opening 326 that can be used to grip the winder 310, and a storage recess 328. The winder 310 is further provided with holes 330 and a cleat 332 for the passage of the guy ropes 312. The tensioner 314 comprises a generally flat, elliptical body having holes 334 and a cleat 336 for the passage of the guy ropes. The guy assemblies 122 are configured to be compact for packing within the transit bag, with the guy ropes 312 wrapped around the spool sections 324 and the tensioner 314 placed in the storage recess 328, as illustrated in FIG. 13.

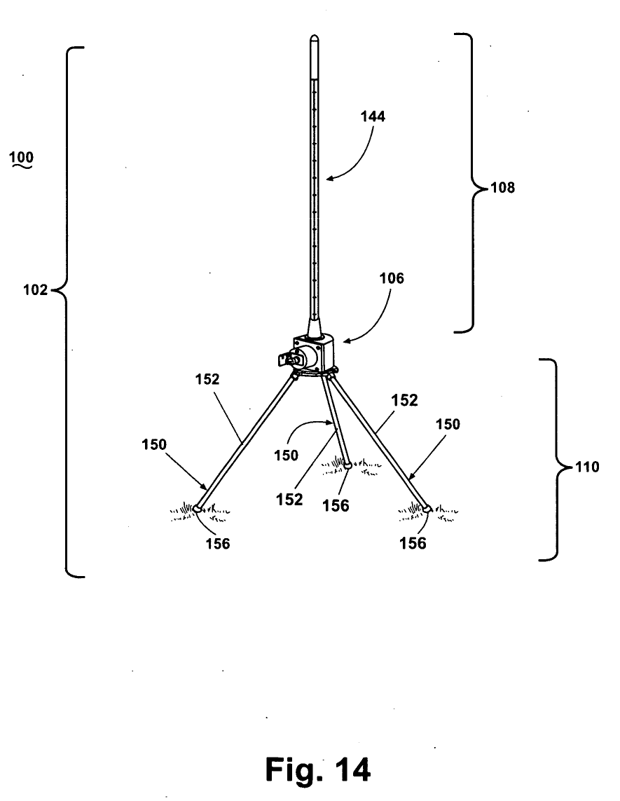

FIG. 2 illustrates a first use configuration of the field antenna 100, in which the antenna assembly 102 is mounted to the mast assembly 104 to support the antenna assembly 104 at an elevated height above the ground. FIG. 14, illustrates a second use configuration of the field antenna 100, in which the antenna assembly 102 is used alone as a field antenna 100 without the mast assembly 104. In the second use configuration, the lower antenna portion 110, with the antenna elements 150 in the unextended position, serves as a tripod for supporting the antenna assembly 102 on the ground. While the reduced elevation of the antenna assembly 102 in the second use configuration may adversely effect performance, but can be erected more quickly since the mast assembly 104 does not need to be assembled.

Referring to FIG. 3, the field antenna 100 is designed to be assembled or disassembled by a single person, and, when disassembled, packed in a transit bag 138 for storage and transport. The transit bag 138 can be provided with suitable pockets and straps to hold the antenna components for transportation. The antenna assembly 102 and mast assembly 104 are configured to be placed in respective collapsed configurations, shown in FIG. 4, and packed without disassembly in the transit bag 138. Other ancillary components used for assembling the field antenna 100, such as a technical manual 140, a hammer 142, and optional spare parts are also stored in the transit bag 138. Together, the field antenna 100, the transit bag 138 and the ancillary components comprise an antenna kit that can be provided for field use. As illustrated, the spare parts of the antenna kit include two antenna elements 150 preassembled with antenna heads 184, two pivot pins 234 and a guy stake 126. Optionally, the antenna kit can further comprise one or more connector adapters 340 that are used to connect the cable 132 between various types of radios, such as an N-type or BNC-type radio. In their respective collapsed configurations, the antenna assembly is approximately 6 ft. in length and the mast assembly is approximately 5.5 ft. in length. When disassembled, the packed transit bag 138 weighs approximately 41 lbs and measures approximately 75 inches long, 12 inches wide and 4 inches thick.

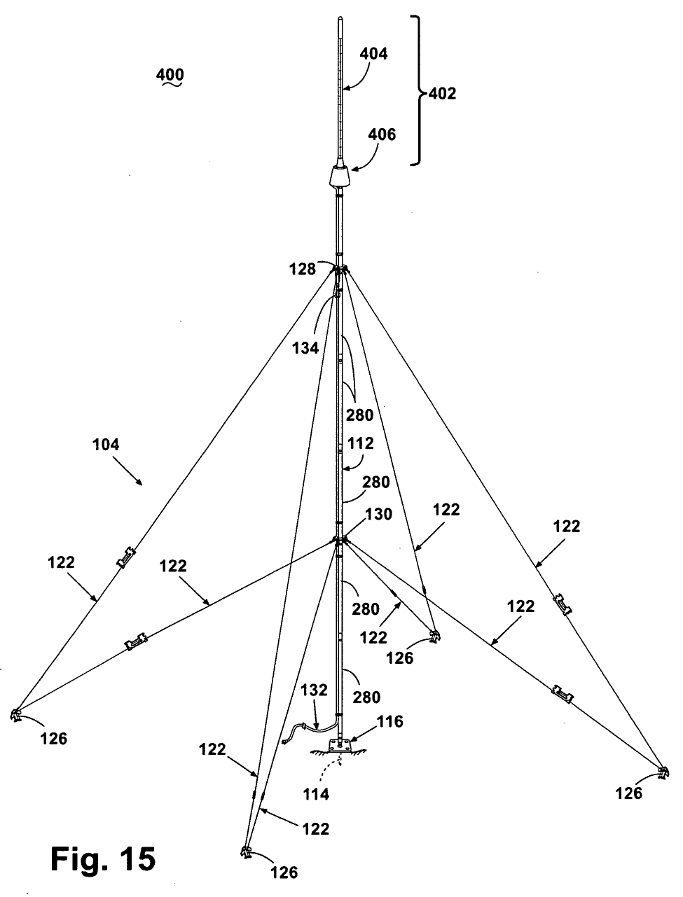

Referring to FIG. 15, field antenna 400 having an antenna assembly 402 according to a second embodiment of the invention is illustrated. The antenna assembly 402 comprises a single upwardly extending antenna element 404 projecting approximately vertically from a mounting base 406. The antenna element 404 can comprise a multiband antenna, as described above with reference to antenna element 144, or a continuous band antenna (CBA). A CBA can effectively transmit/receive at several frequency bands, such as 30-88 MHz, 108-512 MHz, and 530-2000 MHz with little loss between bands.

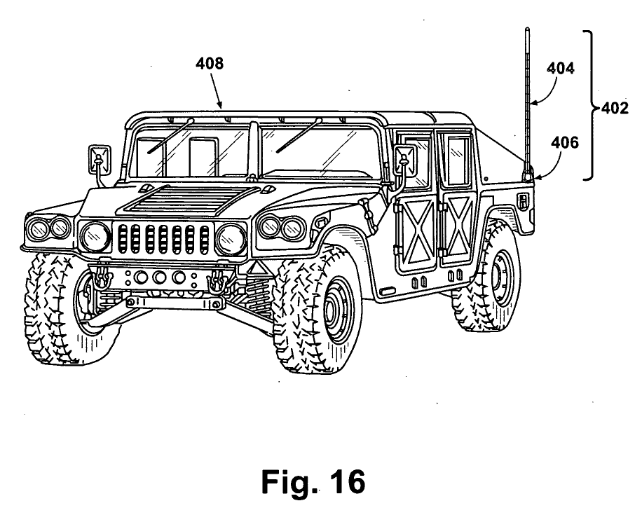

Referring to FIGS. 15 and 16, the antenna assembly 402 can be interchangeably mounted on different supporting structures. For example, as illustrated in FIG. 15, the antenna assembly 402 can optionally be supported by the mast assembly 104 at an elevated height above the ground for use as a field antenna 400. The antenna assembly 402 can be connectable to the mast assembly 104 via the mounting base 406. Alternately, or in addition to the mounting base 406, a separate removable coupler (not shown) can be used to connect the antenna assembly 402 to the mast assembly 104, and may be part of the antenna kit. Alternately, as illustrated in FIG. 16, the antenna assembly 402 can be removably coupled to a vehicle 408 via the mounting base 406 or a separate removable coupler (not shown). Further, several different antenna assemblies could be provided, any of which could be mounted to the mast assembly 104 or vehicle. For example, both antenna assemblies 102, 402 could be provided in the antenna kit. Thus, a field antenna could be erected with either embodiment of the antenna assembly, depending on the bandwidth required.

The forgoing disclosure sets forth an improved field antenna. The field antenna can be used for transmission or reception in multiple frequency bands, including the 30-88 MHz VHF band and the 225-450 MHz UHF band when connected to a radio which operates in the 30-88 MHz or 225-450 MHz frequency range, or in continuous frequency bands, including 30-88 MHz, 108-512 MHz, and 530-2000 MHz. The field antenna has a power capability of up to approximately 100 watts. An antenna kit comprising the field antenna packed in the transit bag weighs less than similar prior art antenna kits. The field antenna comprises a greatly reduced number of separate parts, including having a unitary antenna assembly and an optional unitary mast. One embodiment of the antenna assembly can further be used as a field antenna without the mast assembly if a quick set-up is desired. Another embodiment of the antenna assembly can further be selectively coupled to a vehicle or the mast assembly.

While the invention has been specifically described in connection with certain specific embodiments thereof, it is to be understood that this is by way of illustration and not of limitation. Reasonable variation and modification are possible within the scope of the forgoing disclosure and drawings without departing from the spirit of the invention which is defined in the appended claims.

What is claimed is:

1. A field antenna for portable transport comprising:
an antenna assembly comprising:
an upper antenna portion having a single upper antenna element capable of operating in a first frequency range and a second, higher frequency range;
a lower antenna portion having multiple lower antenna elements capable of operating in the first frequency range; and
a feedcone assembly connecting the upper and lower antenna portions, and having a lower antenna mounting assembly that movably mounts the lower antenna elements to the feedcone assembly.

2. The field antenna assembly according to claim 1 and further comprising a mast assembly for optionally supporting the antenna assembly at an elevated height above a ground surface.

3. The field antenna assembly according to claim 2 wherein the mast assembly comprises a telescopic mast connectable to the feedcone assembly.

4. The field antenna assembly according to claim 3 and further comprising a plurality of guy assemblies attached between the mast and the ground surface for supporting the mast in a generally vertical orientation.

5. The field antenna assembly according to claim 2 wherein the feedcone assembly has a mast mounting assembly configured to removably mount the feedcone assembly to the mast assembly.

6. The field antenna assembly according to claim 2, and further comprising an insulating extension between the mast assembly and the feedcone assembly.

7. The field antenna assembly according to claim 2, and further comprising an adapter for connecting the feedcone assembly to the mast assembly.

8. The field antenna assembly according to claim 1 wherein the upper antenna element comprises a multiband antenna.

9. The field antenna assembly according to claim 1 wherein the multiple lower antenna elements comprises three lower antenna elements.

10. The field antenna assembly according to claim 1 wherein each of the lower antenna elements is telescopic and comprises at least one outer tubular section and at least one inner tubular section that is moveable with respect to the at least one outer tubular section for receipt within a portion of the at least one outer tubular section.

11. The field antenna assembly according to claim 1 wherein the lower antenna elements are movable between a collapsed configuration in which the lower antenna elements are folded to lie generally parallel to the upper antenna element, and a use configuration in which the lower antenna elements project from the feedcone assembly in a cone configuration.

12. The field antenna assembly according to claim 11 wherein each of the lower antenna elements is telescopic, and in the use configuration the lower antenna elements are extended, and in the collapsed configuration the lower antenna elements are unextended.

13. The field antenna assembly according to claim 11 wherein the lower antenna elements are configured to support the field antenna directly on a ground surface in the use configuration.

14. The field antenna assembly according to claim 11 wherein the lower antenna mounting assembly further comprises a lock to lock the lower antenna elements in the use configuration.

15. The field antenna assembly according to claim 1 wherein the feedcone assembly further comprises an upper antenna mounting assembly that mounts the upper antenna element to the feedcone assembly in a generally vertical orientation.

16. The field antenna assembly according to claim 15 wherein the upper antenna mounting assembly removably mounts the upper antenna element to the feedcone assembly.

17. The field antenna assembly according to claim 1 wherein the lower antenna elements are pivotally mounted relative to the feedcone assembly between a collapsed configuration and a use configuration.

18. The field antenna assembly according to claim 17 wherein the lower antenna mounting assembly comprises at least one conducting surface that is used to establish a conducting path between the lower antenna portion and the feedcone assembly when the lower antenna elements are in the use configuration.

19. The field antenna assembly according to claim 17 wherein the lower antenna mounting assembly comprises a rotatable plate having multiple recesses that correspond to the multiple lower antenna elements, where the recesses are aligned with the lower antenna elements to pivot the lower antenna elements between the collapsed and use configurations, and where the recesses are offset with the lower antenna elements to lock the lower antenna elements in the use configuration.

20. A field antenna for portable transport comprising
a mast assembly comprising a mast and a plurality of guy assemblies attached between the mast and a ground surface for supporting the mast in a generally vertical orientation;
an antenna assembly optionally supported by the mast assembly at an elevated height above a ground surface, comprising:
a mounting base removably mountable to the mast; and
a single antenna element mounted to the mounting base and capable of operating in a first frequency range and a second, higher frequency range;
whereby the antenna assembly is selectively mountable to one of the mast assembly and a vehicle.
